(19) United States
(12) Patent Application Publication
(10) Pub. No.: US 2025/0358357 A1
(43) Pub. Date: Nov. 20, 2025

(54) PORTABLE INFORMATION TERMINAL, WIRELESS CONNECTABLE EXTERNAL DEVICE, AND INFORMATION PROCESSING METHOD FOR THEM

(71) Applicant: Maxell, Ltd., Kyoto (JP)

(72) Inventors: Hitoshi AKIYAMA, Kyoto (JP); Tamotsu ITO, Kyoto (JP)

(21) Appl. No.: 18/871,511

(22) PCT Filed: Jun. 8, 2022
(86) PCT No.: PCT/JP2022/023036

§ 371 Date: Dec. 4, 2024

(51) Int. Cl. H04M 1/72412; G06T 19/00; H04M 1/72409; H04W 4/029; H04W 4/80

(52) U.S. Cl. CPC H04M 1/72412; G06T 19/006; H04M 1/724097; H04M 2250/02; H04W 4/029; H04W 4/80

(57) ABSTRACT

A portable information terminal is provided with a first communication function and a second communication function that can be wirelessly connected to the external device, a camera that captures video of a surrounding of the portable information terminal, a video processing unit that processes the video captured by the camera, a display that displays the video processed by the video processing unit, a memory unit that stores first identification information of the external device used for the first communication function, and second identification information of the external device used for the second communication function, and a control unit. The control unit calculates a relative position of the external device to the portable information terminal using the second communication function, and generates an overlaid video in which the first identification information is overlaid on the calculated relative position of an external device in the video and displays it on the display.

### TECHNICAL FIELD

The present invention relates to a portable information terminal that provides an external device selection assistance method for a portable information terminal to select an external device that can be connected wirelessly.

### BACKGROUND ART

In recent years, wireless data communication between digital devices over a short distance has become common, especially with regard to the Bluetooth (registered trademark) wireless communication standard, which is being applied to not only information terminals such as PCs and smartphones, but also to external devices including speakers and earphones. Here, it is commonly used to search for external devices that can be connected wirelessly through broadcast communication. However, even if a wireless-connectable external device can be detected, it is difficult to accurately determine both its position, i.e., direction, and distance.

On the other hand, portable information terminals equipped with UWB (ultra wide band) communication functions, which are ultra wide band wireless communications, are beginning to emerge. This UWB communication function allows position detection with high accuracy. In general, position accuracy with Bluetooth is measured in meters, while position accuracy with UWB is measured in centimeters.

Patent document 1 is a background technology in this technical field, which discloses that an external wireless terminal with Bluetooth communication functionality transmits device name information that is transmitted in the scan process, together with the position information of the external wireless terminal.

### CITATION LIST

### Patent Document

Patent Document 1: Patent Publication No. 2013-247428

### SUMMARY OF THE INVENTION

### Problems to Be Solved by the Invention

The patent document 1 has problems such as the need for the external wireless terminal side to acquire the location information of the external wireless terminal and the fact that the position information is based on the Global Positioning System (GPS), so it cannot be applied indoors or in other places where GPS radio waves cannot be received. In addition, the patent document 1 shows an example of displaying the relative position of an external wireless terminal on a screen, but it is necessary for the user to determine whether the external wireless terminal displayed on the screen matches the external wireless terminal that actually exists. This makes the operation of selecting the external wireless terminal to be connected not intuitive, and there was a risk of making a mistake in selecting the external wireless terminal.

Considering the above issues, the purpose of the present invention is to provide a portable information terminal that can identify the position of a plurality of external devices having Bluetooth communication functions and, from among the plurality of external devices having Bluetooth communication functions, to intuitively identify the external device to be connected based on the position of the external device that has been identified.

### Solutions to Problems

The present invention, to give an example, is a portable information terminal that can be wirelessly connected to an external device, and that includes a first communication function and a second communication function that can be wirelessly connected to the external device, a camera that captures video around the portable information terminal, a video processing unit that processes the video captured by the camera, a display that displays the video processed by the video processing unit, a memory unit that memorizes a first identification information of the external device used in the first communication function and a second identification information of the external device used in the second communication function, and a control unit. The control unit calculates the relative position of the external device to the portable information terminal using the second communication function, and the video processing unit generates an overlaid video in which the first identification information is overlaid on the calculated relative position of the external device in the video and displays it on the display.

### Effects of the Invention

According to the present invention, external device identification information is overlaid on the external device image extracted from the captured image, and the appearance of the external device and its identification information can be easily identified and matched. This makes it possible for users to intuitively select the external device they wish to connect.

### BRIEF DESCRIPTION OF THE DRAWINGS

FIG. 1 shows a schematic diagram of the entire system in Example 1.

FIG. 2 shows an external view of the HMD in Example 1.

FIG. 3 shows a block diagram of the hardware configuration of the HMD in Example 1.

FIG. 4 shows a functional block diagram of the HMD in Example 1.

FIG. 5 shows a flowchart of the external device selection support process in Example 1.

FIG. 6 shows a flowchart of advertisement scan process of the HMD in Example 1.

FIG. 7 shows a flowchart of UWB connection process of the HMD in Example 1.

FIG. 8 shows a block diagram of the main hardware of the external device conforming to Example 1.

FIG. 9 shows a flowchart of the advertisement scan process of an external device conforming to Example 1.

FIG. 10 shows a flowchart of the UWB connection process of an external device conforming to Example 1.

FIG. 11 shows the external device information table that contains the external device information for Example 1.

FIG. 12 is a schematic diagram to illustrate the principle of calculating the external device position in Example 1.

FIG. 13 is a schematic diagram showing an example of the display of the external device name in Example 1.

FIG. 14A is a schematic diagram showing an example of the display of the external device name in Example 2.

FIG. 14B is a schematic diagram showing an example of the display of the external device name in Example 2.

FIG. 14C is a schematic diagram showing an example of the display of the external device name in Example 2.

FIG. 14D is a schematic diagram showing an example of the display of the external device name in Example 2.

FIG. 15A is a schematic diagram showing an example of the display of the external device position and device name in Example 3.

FIG. 15B is a schematic diagram showing an example of the display of the external device position and device name in Example 3.

FIG. 16 is a schematic diagram showing an example of the display of the external device name in Example 4.

FIG. 17 is a schematic diagram showing an example of the display of the external device name in Example 5.

FIG. 18 is a schematic diagram illustrating the overall system in Example 6.

FIG. 19 shows a view of the portable information terminal in Example 6.

FIG. 20 shows a flowchart of the external device selection support process in Example 7.

FIG. 21 shows the external device information table that contains the external device information in Example 7.

### MODE FOR CARRYING OUT THE INVENTION

The examples of the invention are described below with drawings.

### Example 1

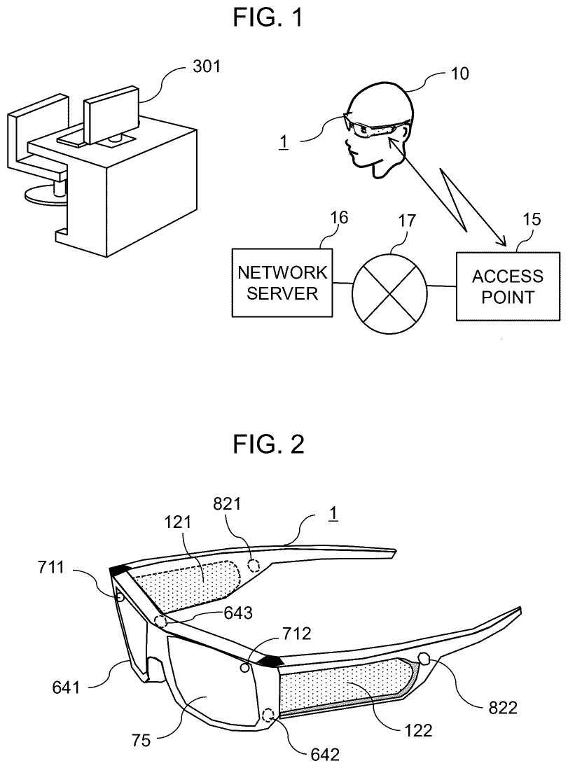

FIG. 1 is a schematic diagram of the entire system in this example. In FIG. 1, user 10 wears an eyeglass-shaped transparent HMD (Head Mounted Display) 1, which is a portable information terminal, and a user 10 is exploring whether an external device capable of Bluetooth communication with the HMD1 worn by the user 10 is present within the field of view of the HMD1. The details of the search procedure will be described later, but the HMD 1 searches to see if the desktop PC 301 in the field of view is capable of Bluetooth communication with the HMD 1 as an external device. HMD 1 is connected to network 17 to which network server 16 is connected via access point 15. The network server 16 includes a network server that performs various calculations and a network server that stores various data, which can be utilized by HMD 1 as needed.

FIG. 2 is an external view of the HMD in this example. In FIG. 2, HMD 1 has a display screen 75 at the left and right lens positions of the glasses, and a right camera 711 at the right end of the right lens position of the glasses and a left camera 712 at the left end of the left lens position of the glasses. The user of the HMD 1 can see the real space through the transparent display screen 75. The display screen 75 can show augmented reality (AR) objects. Therefore, the user 10 wearing HMD 1 can simultaneously view both the augmented reality AR objects displayed on the display screen 75 and the situation in the real space. The right speaker 821 and the left speaker 822 are placed on the temple of the glasses.

HMD 1 also has UWB communication function and can perform distance measurement with connected devices that have UWB communication function. The transmitting and receiving ANTENNA for UWB communication are right UWB antenna 641 at the rightmost bottom of HMD 1, left UWB antenna 642 at the leftmost bottom of the HMD1, and central UWB antenna 643 at the center position of HMD 1.

The specific configuration and methods in this example are described below. In this example and in the drawings, identical functions are described with the same symbols.

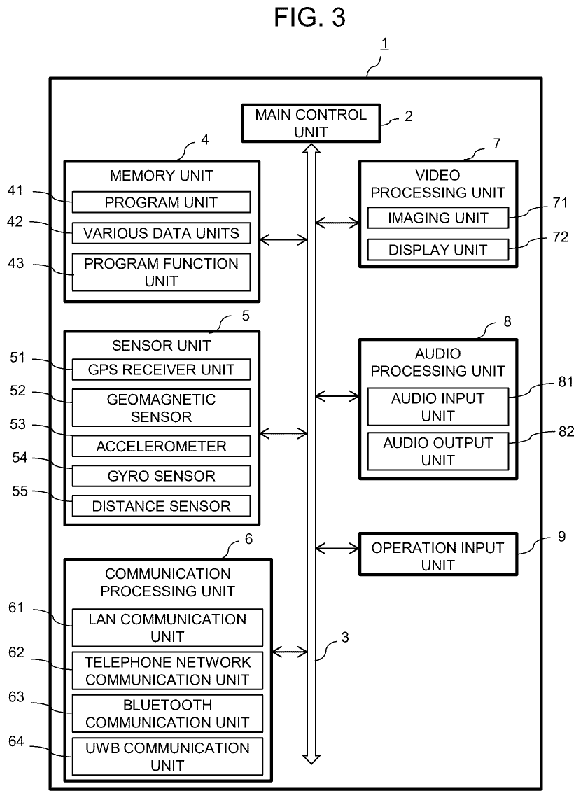

FIG. 3 shows a block diagram of the hardware configuration of the HMD in this example. In FIG. 3, HMD1 has a main control unit 2, system bus 3, memory unit 4, sensor unit 5, communication processing unit 6, video processing unit 7, audio processing unit 8, and operation input unit 9.

The main control unit 2 is a microprocessor unit that controls the entire HMD 1 according to a predetermined operating program. The system bath 3 is a data communication channel for sending and receiving various commands and data between the main control unit 2 and each component block in the HMD 1.

The memory unit 4 consists of program unit 41, which stores programs to control the operation of the HMD 1, etc.; various data units 42, which stores various data, such as operation setting values, detection values from sensor units, objects containing contents, and library information downloaded from libraries; and program function unit 43, which can be rewritten such as work areas used for various program operations. The memory unit 4 can store operating programs downloaded from the network and various data created by operating programs. In addition, memory unit 4 can store contents such as video, still images, and sound downloaded from the network, as well as video and still image data captured by the camera. In addition, the memory unit 4 can store necessary information (setting values such as threshold values, image data, etc.) in advance. The memory unit 4 must retain the stored information even when the HMD 1 is turned off, and devices such as flash ROM, semiconductor device memory such as SSD (Solid State Drive), and magnetic disk drives are used. Each operating program stored in memory unit 4 can be updated and extended by downloading from server devices on the network.

Sensor unit 5 is a group of various sensors for detecting the HMD 1 and surrounding conditions. The sensor unit 5 consists of a GPS receiver unit 51, a geomagnetic sensor 52, an accelerometer 53, a gyro sensor 54, and a distance sensor 55. These sensor groups make it possible to detect the position, tilt, direction, and motion of the HMD1. Furthermore, the HMD 1 may be equipped with other sensors such as an illumination sensor, an altitude sensor, etc.

The communication processing unit 6 consists of a LAN (Local Area Network) communication unit 61, a telephone network communication unit 62, a Bluetooth communication unit 63, and a UWB communication unit 64. The LAN communication unit 61 is connected to a network 17 such as the Internet via an access point 15, etc., and transmits and receives data from each network server 16 on the network 17. The connection with the access point 15, etc. is made by a wireless connection such as Wi-Fi (registered trademark). The telephone network communication unit 62 transmits and receives telephone communication (calls) and data through wireless communication with base stations of mobile telephone communication networks. Communication with base stations can be made by LTE (Long Term Evolution), 5G (5th generation mobile communication system for high speed, high capacity, low latency, and multiple simultaneous connections), or other communication methods. The Bluetooth communication unit 63 performs Bluetooth communication with external devices that have Bluetooth communication functions, including the advertisement scan process and data communication described below. The UWB communication unit 64 performs UWB communication such as UWB connection processing and UWB data communication with external devices that have UWB communication functions. The LAN communication unit 61, the telephone network communication unit 62, the Bluetooth communication unit 63, and the UWB communication unit 64 are equipped with encoding and decoding circuitry and antennas, respectively. In particular, the UWB antenna in the UWB communication unit is an important part related to positioning, and the three UWB antennas are arranged in consideration of positioning. In addition, communication processing unit 6 may be equipped with other communication units, such as an infrared communication unit.

The video processing unit 7 consists of an imaging unit 71 and a display unit 72. The imaging unit 71 is a camera that acquires image data of the surroundings and objects by converting light input from the lens into electrical signals with an electronic device such as a CCD (Charge Coupled Device) or CMOS (Complementary Metal Oxide Semiconductor) sensor. In this example, the imaging unit 71 consists of a right camera 711 and a left camera 712. The display unit 72 is a display device of a transmissive display using, for example, a translucent liquid crystal, which constitutes a display screen 75 to display AR objects and incidental information, etc. to the user 10 of the HMD 1.

The audio processing unit 8 consists of audio input unit 81 and audio output unit 82. The audio input unit 81 is a microphone that converts sounds in real space and the user's voice into voice data. For example, the microphones are placed near the right camera 711 and the left camera 712, respectively. The audio output unit 82 is a speaker that outputs audio information necessary for the user, etc. Of course, earphones or headphones can also be connected and used according to the purpose. The operation input unit 9 is an operation input unit for inputting operation instructions, etc. to the HMD 1.

The example hardware configuration of HMD 1 shown in FIG. 3 includes many configurations that are not essential for this example, but even if these configurations are not provided, the effect of this example is not impaired. Further configurations not shown, such as electronic payment functions, may be added.

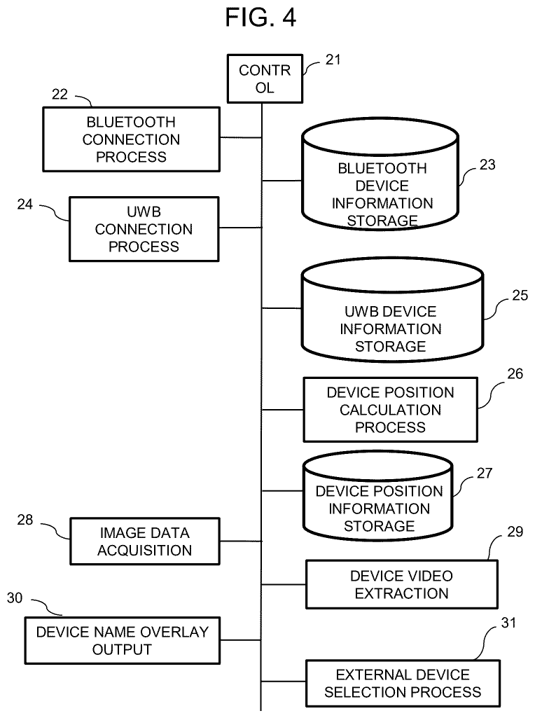

FIG. 4 shows the functional block diagram of the HMD in this example. In FIG. 4, control 21 is the function that controls the entire HMD1 and is mainly handled by the main control unit 2 and the program function unit 41 and program function unit 43 of memory unit 4.

Bluetooth connection process 22 is a function that performs an advertisement scan process with an external device that has Bluetooth communication function using Bluetooth communication unit 63 of communication processing unit 6. The Bluetooth device information storage 23 is a function to store the device information of the external device obtained in the advertisement scan process in the Bluetooth connection process 22 in the various data units 42 of the memory unit 4.

The UWB connection process 24 is a function to perform polling response message processing with external UWB devices that have UWB communication functions using the UWB communication unit 64 of the communication processing unit 6. The UWB device information storage 25 is a function to store the device information of the external UWB device obtained through the polling response message processing in UWB connection process 24 in various data units 42 in memory unit 4. The device position calculation process 26 is a function to calculate the distance between the HMD 1 and the external UWB device that have UWB communication functions by transmitting and receiving between HMD1 and external UWB devices that have UWB communication functions through the UWB connection process 24, based on the elapsed time of transmission and reception. The specific method is described below, but the distance from each of the right UWB antenna 641, left UWB antenna 642, and center UWB antenna 643 to the external device is calculated to calculate the relative position between HMD1 and the external UWB device. The device position information storage 27 is a function to store the relative position information between the HMD 1 and the external device calculated by the device position calculation process 26 in the various data unit 42 of the memory unit 4.

The image data acquisition 28 is a function that takes images of near the relative positions between HMD 1 and the external device stored by the device position information storage 27 using the imaging unit 71 of the video processing unit 7 and acquires the imaging data. The device video extraction 29 is a function that analyzes the image data acquired by image data acquisition 28 and extracts images of the external device.

The device name overlay output 30 is a function that overlays the device name in the device information of the external device stored by the Bluetooth device information storage 23 on the display unit 72 of the video processing unit 7 using an AR object. Specifically, the device name in the device information of the external device stored by the Bluetooth device information storage 23 is overlaid and displayed by the AR object near the relative position between the HMD 1 and the external device stored by the device position information storage 27.

The external device selection process 31 selects an external device from the external device name overlaid by the device name overlay output 30. The external device selection process 31 is a function to select an external device to be connected by the user 10 through the operation of the operation input unit 9.

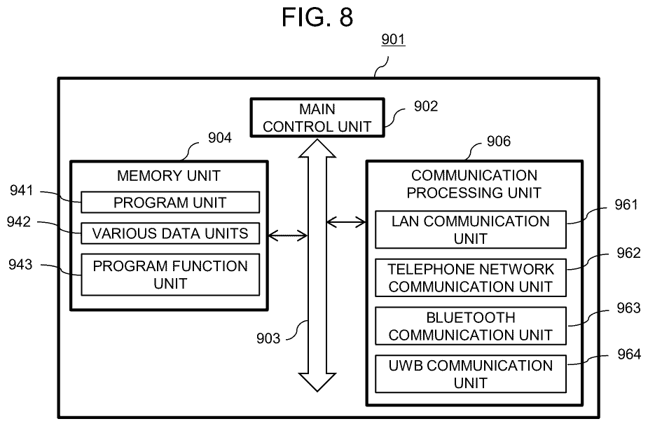

In this example, the feature function is realized by an external device that communicates with HMD 1. The external device is, for example, the desktop PC 301 shown in FIG. 1. FIG. 8 is a block diagram of the main hardware configuration of the external device 901 adapted to this example. In FIG. 8, the basic configuration is the same as that of the HMD 1 in this example shown in FIG. 3, with the main control unit 902, system bath 903, memory unit 904, and communication processing unit 906 to conform to this example. The memory unit 904 consists of program unit 941, various data units 942, and program function unit 943. Communication processing unit 906 consists of LAN communication unit 961, telephone network communication unit 962, Bluetooth communication unit 963, and UWB communication unit 964. The description of each block is the same as that in FIG. 1 and is omitted here. Note that FIG. 8 shows only the configuration necessary to implement this example, and other configurations may be added to realize other functions.

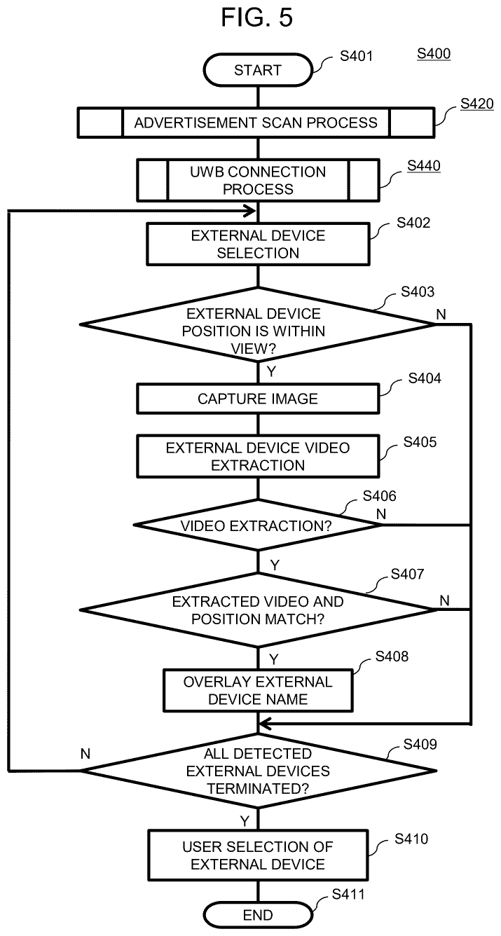

FIG. 5 is a flowchart showing the procedure of the external device selection support process (S400) in this example. The processing procedure in FIG. 5 is explained below with reference to the functional block diagram in FIG. 4.

In FIG. 5, when S400 is started (S401), the advertisement scan process (S420), a subroutine is first executed. The advertisement scan process is intended to obtain device information of the external device by Bluetooth connection process 22.

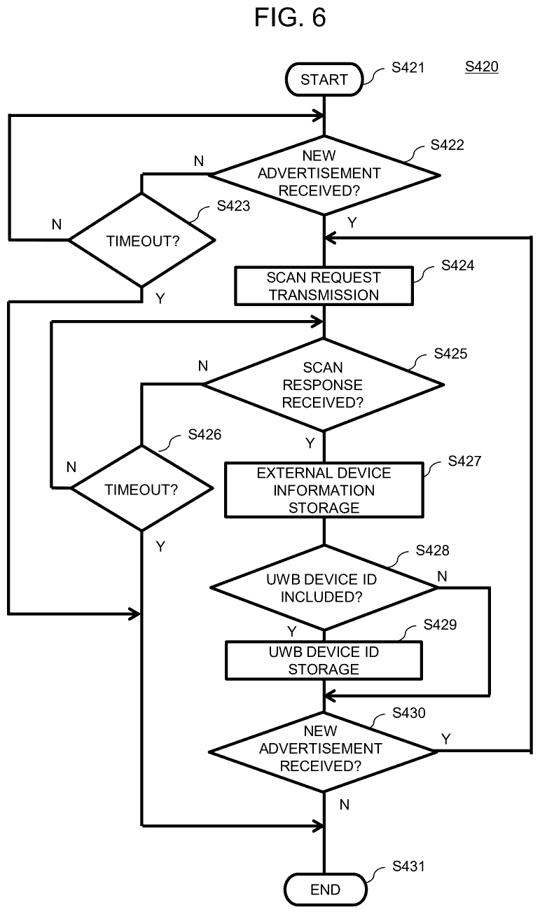

The subroutine advertisement scan process (S420) is described here. FIG. 6 is a flowchart showing the processing steps of the advertisement scan process (S420). The processing procedure in FIG. 6 is explained below with reference to the functional block diagram in FIG. 4.

In FIG. 6, when the process in S420 is started (S421), it first determines whether or not new advertising data has been received (S422). Advertising is a phase in which an external device with Bluetooth communication functions transmits advertising data to the outside world via broadcast communication. The advertising data includes the device name of the external device.

If it is determined in S422 that new advertisement data could not be received, the process moves to S423. In S423, a timeout judgment is made, and if it is determined that the predetermined time has not been reached, the process moves again to S422. In S423, if the predetermined time is reached, this S420 process is terminated (S431).

If the decision process in S422 determines that new advertisement data has been received, the process moves to the scan request transmission process (S424). If multiple new advertisement data can be received, HMD1 selects the first new advertisement data detected during the polling search for external devices and executes the process in S424. In the scan request transmission process (S424), HMD 1 transmits a scan request to the external device that is sending the new advertisement data determined by the decision process in S422.

Next, HMD 1 determines whether a scan response has been received from the target external device (S425). If it is determined that no scan response has been received from the target external device in S425, it moves to S426. In S426, a timeout judgment is made, and if the predetermined time has not been reached, the process moves to S425 again. In S426, if the predetermined time is reached, the process in S420 is terminated (S431). If it is determined in S425 that a scan response could be received from the target external device, Bluetooth device information storage 23 stores the device information of the external device including device name (S427).

Next, it determines whether the UWB device ID is included in the information from the received external device (S428). If it is determined at S428 that the UWB device ID is included in the information from the received external device, the UWB device ID is stored in a table using UWB device information storage 25 (S429), and the process moves to S430. The details of the table are described below. If S428 determines that the UWB device ID is not included in the information received from the external device, the process moves to S430.

At S430, it is determined whether or not new advertising data has been received. If it is determined that new advertising data has been received at S430, it returns to the scan request transmission process of S424 again. If it is determined that the new advertising data could not be received at S430, it means that there is no new external device, and S420 ends (S431). The above is the process of S420 (advertisement scan process), the subroutine shown in FIG. 6.

Now, we return to the process in FIG. 5. In FIG. 5, when the subroutine advertisement scan process (S420) is completed, the process move to the subroutine UWB connection process (S440).

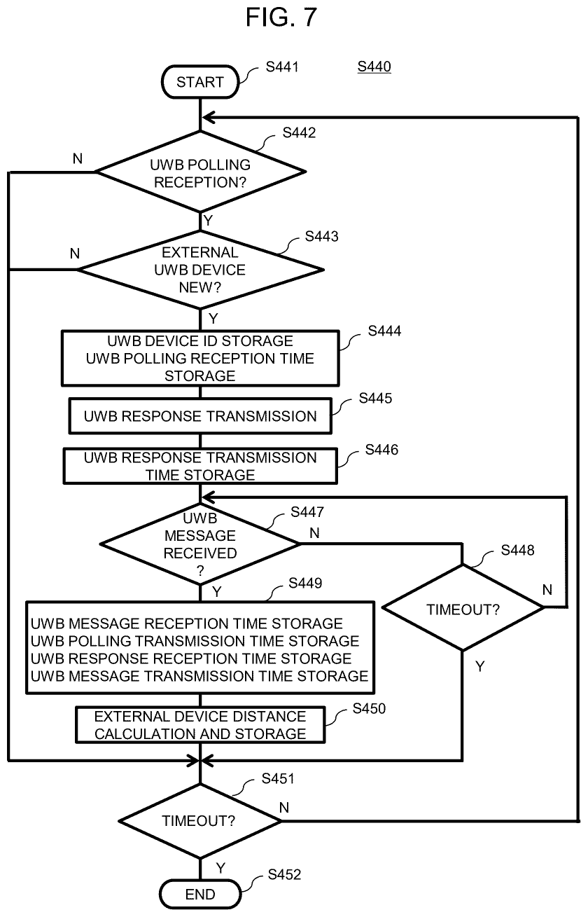

Next, the processing of the UWB connection process (S440) is described. FIG. 7 shows a flowchart of the UWB connection process (S440).

In FIG. 7, when the process of S440 is started (S441), it first determines whether the UWB polling signal from the external UWB device could be received (S442). If it is determined the UWB polling signal from the external UWB device is not received in S442, the process moves to S451. If it is determined the UWB polling signal from the external UWB device is received in S442, the process moves to S443. The UWB polling signal from the external device contains the UWB device ID of the external device, and HMD 1 can acquire the UWB device ID information of the external device.

S443 is the process to determine whether the UWB device ID of the acquired external device is new or not. If it is determined in S443 that the UWB device ID of the acquired external device is not new, the process moves to S451. If it is determined in S443 that the UWB device ID of the acquired external device is new, the process moves to S444.

S444 is the process of storing the acquired UWB device information in a table by UWB device information storage 25. In S444, the UWB device ID obtained from the received external device UWB polling signal and the reception time when the UWB polling signal was received are stored in a table by UWB Device Information Storage 25.

Next, the UWB response transmission process (S445) is performed to transmit the UWB response to the external UWB device, and then the UWB response transmission time, which is the transmission time of the response transmitted to the external UWB device, is stored in a table by UWB device information storage 25 (S446).

Next, it determines whether the UWB message signal from the external device could be received or not (S447). If it is determined that the UWB message signal from the external device could not be received in S447, it moves to S448. S448 is a time-out determination process. If it is determined that the predetermined time has not been reached in S448, it moves to S447 again; if it is determined that the predetermined time has been reached in S448, it moves to S451. Although S448 is a process of simply waiting for the reception of UWB messages, it is necessary to avoid a system deadlock. If it is determined in S447 that the UWB message signal from the external device has been received, the process moves to S449.

S449 is the UWB device information storage process, in which UWB device information storage 25 stores the reception time when a UWB message is received in HMD 1 and the UWB device information (UWB polling transmission time, UWB response reception time, UWB message transmission time) acquired by the UWB message signal in a table.

Next, the relative distance to the external device is calculated, and the calculated relative distance is stored in a table using device position information storage 27 (S450). The detailed process of distance calculation is described below.

Next, the process moves to S451, which is the timeout judgment process, and returns to S442 if it is determined that the timeout has not occurred. If it is determined in S451 that the timeout has occurred, the process in S440 is terminated (S452). In the timeout judgment process of S451, a time sufficiently longer than the generation cycle of the UWB polling signal is set. The user 10 can also terminate the process arbitrarily. The above is the process of S440 (UWB connection process), the subroutine shown in FIG. 7.

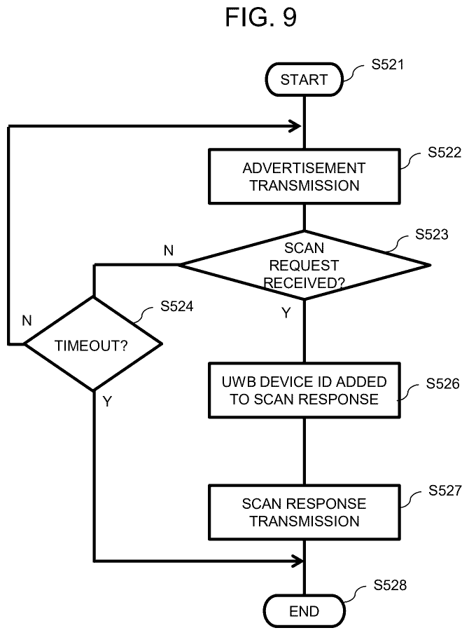

In order for HMD 1 in this example to realize its function, it needs to be connected to an external device that is compatible with this example. Therefore, we will explain the processing of the external device compatible with this example, especially the advertisement scan process. FIG. 9 is an example of a flowchart showing the processing steps of the advertisement scan process in an external device compatible with this example.

In FIG. 9, when processing is started (S521), advertisement data is transmitted via broadcast communication (S522), and then it determines whether a scan request has been received (S523). If it is determined in S523 that a scan request could not be received, the process moves to S524. S524 is a timeout judgment process, and if the predetermined time has not been reached, the process moves to S522 again. If S524 determines that the predetermined time has been reached, the process ends (S528). If it is determined in S523 that the scan request has been received, the process moves to S526.

In S526, the UWB device ID is added to the scan response, and in S527, the scan response with the UWB device ID added is transmitted to HMD 1, and the process ends (S528).

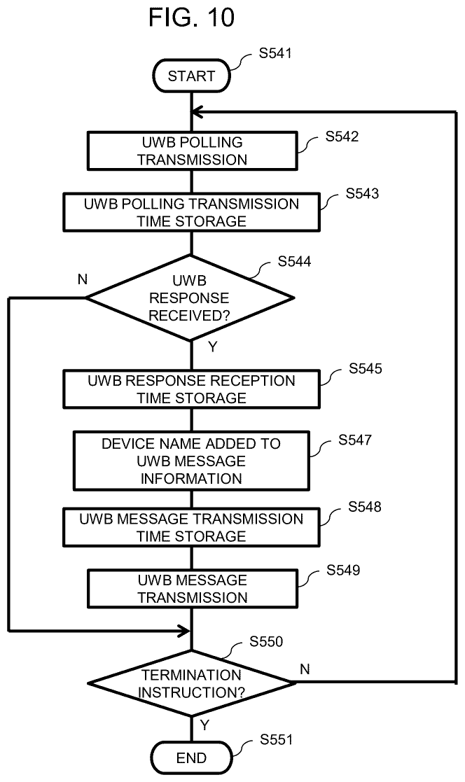

The UWB connection process at the external device assumed in this example is explained here. FIG. 10 is an example flowchart showing the processing steps of the UWB connection process in an external device conforming to this example.

In FIG. 10, when the process is started (S541), the UWB polling signal is transmitted via broadcast communication (S542). At that time, the time at which the UWB polling signal is transmitted is also stored (S543).

Next, it determines whether the UWB response signal from HMD 1 was received or not (S544). If it is determined that the UWB response signal from HMD 1 was not received in S544, it moves to S550. If it is determined that the UWB response signal from HMD 1 was received in S544, the time when the UWB response signal was received is stored (S545).

Next, in S547, the device name is added to the UWB message information; next, in S548, the time at which the UWB message signal is transmitted is stored; in S549, the UWB message signal with the UWB message storage time stored in S548 is transmitted.

Next, it moves to the process of determining whether or not there is a termination instruction (S550); if it is determined that there is no termination instruction in S550, it returns to S542. If there is a termination instruction in S550, the UWB connection process for this external device is terminated (S551).

As explained above, the UWB device ID is added to the scan response in the advertisement scan process in FIG. 9, and similarly, the device name is added to the UWB message information in the UWB connection process in FIG. 10. An external device that conforms to this example may adopt at least one of the processes of adding the UWB device ID to the scan response and adding the device name to the UWB message information. The HMD side may acquire either the device name or the UWB device ID from the external device in response to either of these processes. Which process is adopted may be determined based on the specifications of the external device.

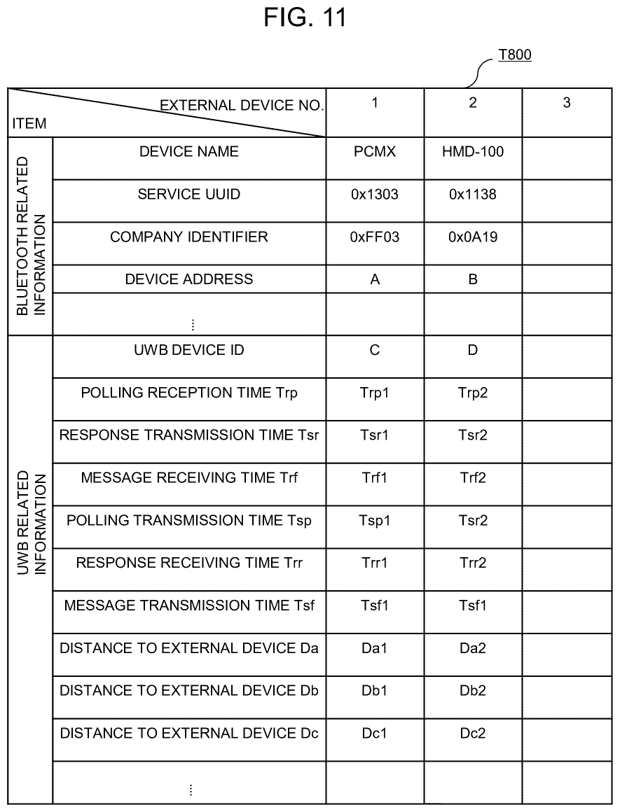

This section describes the external device information tables that store information in Bluetooth device information storage 23 and UWB device information storage 25. FIG. 11 shows an example of an external device information table T800.

The external device information table T800 consists of Bluetooth related information and UWB related information for each external device. The external device number is a number assigned by HMD 1 to identify each external device.

Bluetooth related information consists of device name, service UUID (Universally Unique Identifier) indicating the function, Company Identifier, and device address unique to the device, etc. UWB related information consists of the UWB device ID, polling reception time Trp, response transmission time Tsr, message reception time Trf, polling transmission time Tsp, UWB response reception time Trr, UWB message transmission time Tsf, distance of each antenna to the external device Da, Db, Dc, etc.

Here, the method for calculating the distance to the external device is explained. The distance to the external device is calculated based on the arrival time of the UWB signal. The UWB signal arrival time T can be calculated using the following equation (1), taking into account the fact that the time system of HMD 1 and the time system of the external device are not synchronized (not in the same time system).

$$T = \{ ( Trr - Tsp ) - ( Tsr - Trp ) + ( Trf - Tsr ) - ( Tsf - Trr ) \} / 4 \qquad ( 1 )$$

If the UWB signal arrival time T can be calculated, the distance D to the external device can be calculated using the following equation (2), since the transmission speed of the UWB signal is the speed of light c.

$$D = T \times c \qquad ( 2 )$$

The distance D to the external device is the relative distance from the UWB antenna owned by HMD 1. Therefore, if HMD1 has three UWB antennas (right UWB antenna 641, left UWB antenna 642, and center UWB antenna 643), the distance Da is calculated using the right UWB antenna 641, the distance Db using the left UWB antenna 642, and the distance Dc using the central UWB antenna 643, respectively, and stored in table T800.

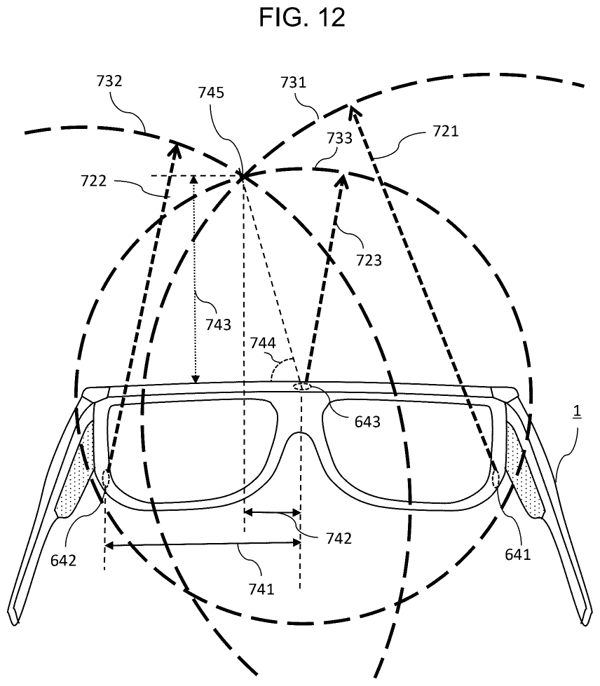

The calculation principle for calculating the relative position of the external device to HMD1 from the distance D from each UWB antenna to the external device is explained here. FIG. 12 shows a schematic diagram of the calculation principle for calculating the relative position of HMD 1 and the UWB device. HMD 1 is equipped with three UWB antennas: right UWB antenna 641, central UWB antenna 643, and left UWB antenna 642.

The intersection point 745 of circle 731 at a linear distance 721 from right UWB antenna 641 to external UWB device, circle 733 at a linear distance 723 from central UWB antenna 643 to external UWB device, and circle 732 at a linear distance 722 from left UWB antenna 642 to external USB device is the position of the external UWB device sought. Specifically, the position of the external UWB device is a distance 742 to the left from the position of the central UWB antenna 643 and a distance 743 to the front of the HMD 1.

The angle 744 from the CENTRAL UWB antenna 643 position can be calculated by the following equation (3).

$$Angle 744 = arctan ( distance 743 / distance 742 ) \qquad ( 3 )$$

Using the above calculation principle, the relative position of the UWB device to the HMD 1 can be calculated.

The obtained information on the relative position of the UWB device to HMD 1 is stored by device position information storage 27. The protocol for UWB is not limited to the protocol described in this example, but other protocols may be used.

At this point, return to FIG. 5 to continue the explanation. After the UWB connection process (S440), which is a subroutine, is completed, the process moves to the external device selection process (S402), which selects external devices that can be connected. In the external device selection process (S402), the external device obtained in the advertisement scan process (S420) is selected. Specifically, the external devices are selected in order of device number in the external device information table T800.

Next, it is determined whether the relative position of the selected external device exists within the field of view of the HMD 1 (S403). Specifically, the relative position of the selected external device is determined uniquely from the distance in the left-right direction and the forward distance, or the linear distance to the external device and its direction (forward angle), starting from the position of the central UWB antenna 643 in the HMD 1. If the relative position of the selected external device is not within the field of view of HMD 1 in S403, the process moves to S409. If the relative position of the selected external device is determined to be within the field of view of the HMD 1 in S403, image data acquisition 28 is used to capture the image (S404). At this time, the image may be enlarged only in the vicinity of the relative position of the external device. The purpose of the shooting process in S404 is to capture an image including the external device.

Next, the external device video is extracted from the captured image in S404 by device video extraction 29 (S405). As an example, objects that exist in the relative position of the external device can be extracted using image recognition technology. Alternatively, the external device's appearance information can be obtained from a server connected via a network. In which case the Bluetooth device name and service UUID (stored by Bluetooth device information storage 23) can be transmitted to the server to retrieve the external device appearance information at the server.

Next, it is determined whether the image of the external device could be extracted or not (S406). If it is determined that the image of the external device could not be extracted in S406, it moves to S409. In S406, if it is determined that the video of the external device could be extracted, the process moves to S407.

In S407, it is judged whether the position of the extracted external device image matches the relative position of the external device detected in the UWB connection process (S440). If it is judged in S407 that the position and relative position of the external device image match, the process moves to S408. Since the extracted external device image has a certain area, it is sufficient to determine whether the relative position is included within that area. It is also possible to expand the area for determining a match by considering the error in the detected relative position information. In addition, the distance of the area corresponding to the extracted external device image may be measured using a distance sensor 55 to determine whether the distance is also consistent. If it is determined that the distance does not match in S407, move to S409.

S408 is the process of generating a video in which the device name, which is Bluetooth device information, is overlaid on the external device position in the video taken by device name overlay output 30, and displaying it on video processing unit 7.

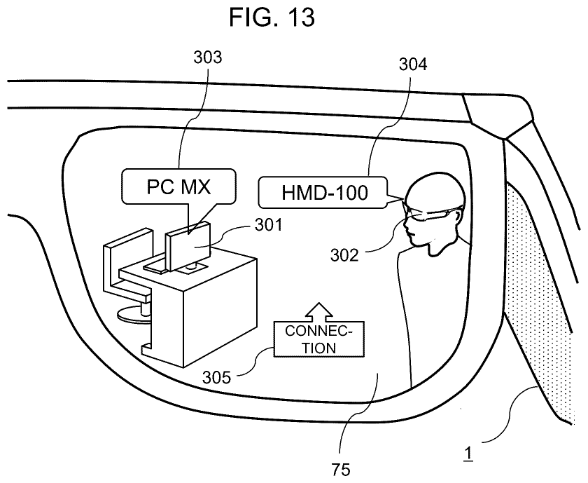

Here, an example of the display of the external device name overlaid display is shown in FIG. 13. FIG. 13 shows a screen that is being viewed by a user 10 wearing HMD 1 through the transparent display screen 75. In FIG. 13, desktop PC 301 and HMD 302 are present in the field of view of HMD 1 as external devices. If desktop PC 301 is an external device conforming to this example, annotation outline 303 is overlaid at the position of desktop PC 301, and the external device name “PC MX” is shown in the outline. Similarly, if HMD302 is an external device conforming to this example, annotation outline 304 is overlaid at the position of HMD302, and the external device name “HMD-100” is shown in it. In this way, the device name is overlaid on the position of the external device in the field of view, allowing the user 10 to intuitively identify the devices that can be connected.

We now return to FIG. 5 to continue the explanation. After the external device name overlayed display processing is performed in S408, it is determined whether the processing has been completed for all detected external devices (S409). If it is determined that processing has not been completed for all detected external devices in S409, it returns to S402. If S409 determines that processing has been completed for all detected external devices, it moves to S410.

S410 is the process of selecting the external device that the user 10 wants to connect by the external device selection process 31. Specifically, as shown in FIG. 13, this is accomplished by displaying a connection cursor 305, moving the cursor position to the annotation outline 303 or 304, and indicating the selection. The connection cursor can be moved, for example, by gesture detection or gaze detection of the user 10, or it can be selected by voice. Specifically, the audio input from the audio input unit 81 of the audio processing unit 8 is recognized by speech recognition, and the selection is made using the result of the speech recognition. For example, when the user 10 speaks “PCMX”, the system determines that it is the same as the external device in the annotation outline 303 and selects desktop PC 301.

This completes the external device selection support process (S400) (S411). The connection process after the external device is selected is the same as the connection process for general Bluetooth communication, so the explanation is omitted.

As explained above, according to this example, the relative distance to an external device is calculated using the UWB communication function, and the positions of multiple external devices with Bluetooth communication functions are determined. Then, external device identification information is overlayed on the external device image extracted from the captured image and displayed, more specifically, the device name of the external device is overlayed on the external device position. This allows the user to easily identify and match the appearance and identification information of the external device to be connected based on the position of the grasped external device among multiple external devices with Bluetooth communication functions. As a result, the user can intuitively recognize the external devices that can be connected. In addition, even when multiple external devices exist, the user can easily and without mistake select the external device to be connected. Furthermore, even if multiple external devices have the same device name, if the relative positions of the external devices are different, it is possible to identify the external device to be connected.

### Example 2

In Example 1, the device names of the connectable external devices were overlaid in the annotation outline 303, but this example describes a different method of overlayed display. The basic hardware and software configuration in this example is the same as in Example 1. Therefore, this example mainly describes the differences from Example 1, and the common parts are omitted.

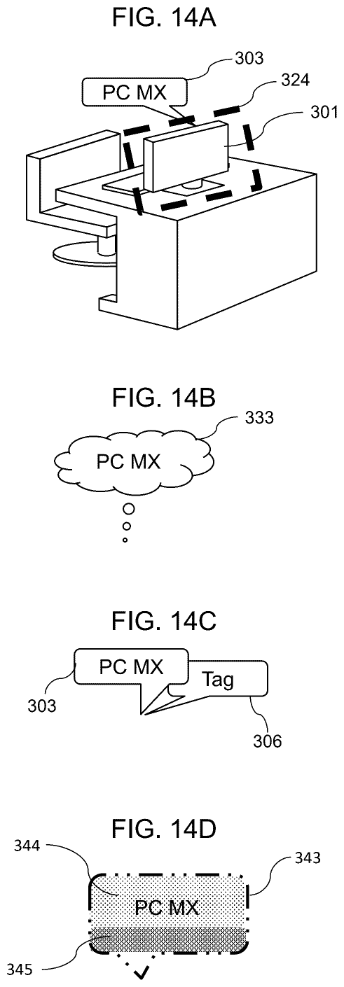

FIG. 14A is a schematic diagram showing an example of displaying the external device name in this example, and is a schematic diagram extracting a part of the image shown in FIG. 13. In FIG. 14A, the same configuration as in FIG. 13 is marked with the same symbol and its explanation is omitted. In FIG. 14A, the device name of the desktop PC 301, which is a connectable external device, is placed inside the annotation outline 303, the outline of the desktop PC 301 is extracted, and highlighted with an outline 324 around the desktop PC 301 so that the extracted external device can be identified. The outline 324 can be further highlighted with a colored outline, blink outline, etc. Also, although not shown in the figure, the entire external device or its outline can be emphasized, for example, by blinking or colorizing it.

In some cases, the relative position of external devices cannot be clearly determined. Specifically, this is the case when the intersection of the linear distance circles from the UWB antenna is not a single point, such as intersection point 745 in FIG. 12. In such a case, the center of the intersection of the three points of the circle of linear distance from the UWB antenna can be used as the relative position of the external device. However, in that case, it means that the relative position of the external device is not accurate enough, so the display may be changed to indicate that the position accuracy is low. For example, as shown in FIG. 14b, it can be a cloud-shaped balloon border line 333. Of course, it goes without saying that other identification indications can also be realized. The display of the outline 324 may be changed according to the extraction accuracy of the external device's outline described above.

There may be cases where multiple external devices exist and the relative position directions of these external devices coincide. In such a case, the external device closest to HMD 1 is displayed in the foremost position, and the presence of the external device behind it is clearly indicated. For example, as shown in FIG. 14C, the annotation outline 306 of the distant external device may be placed behind the annotation outline 303 of the closer external device.

A different display technique can be an annotation 343 indicating the presence of multiple external devices, as shown in FIG. 14D. In FIG. 14D, a two-dashed line annotation 343 indicates the existence of multiple external devices, with the first shaded area 344 indicating the closer external device and the second shaded area 345 indicating the farther external device. In this display method, the device name can be confirmed by selecting the second shaded area 345. Needless to say, other identification displays can also be used to achieve this. This allows the display to distinguish between multiple external devices.

Thus, according to this example, by highlighting the external devices that can be connected, by indicating that the position accuracy is low, and by devising the display method when multiple external devices are present, the user can recognize the connectable external devices more intuitively and can select the external device to be connected more easily and without making a mistake.

### Example 3

In Example 1, it was assumed that the image of an external device existing in the field of view of the user 10 wearing HMD 1 can be extracted, but in this example, we explain the measures to be taken when the image of the external device cannot be extracted. The basic hardware and software configuration in this example is the same as in Example 1. Therefore, this example mainly describes the differences from Example 1, and the common parts are omitted.

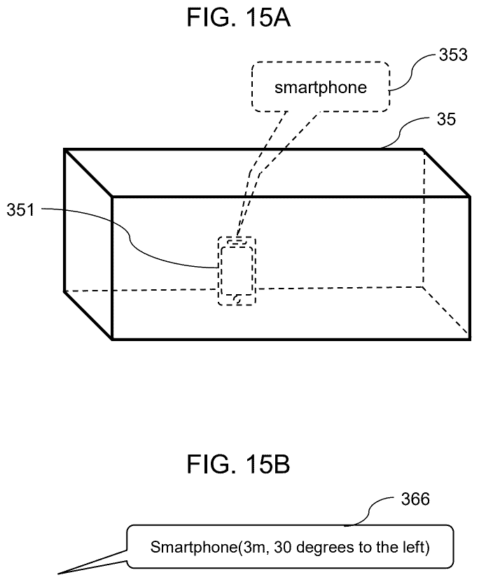

A possible situation where the image of the external device cannot be extracted is when it is not visible, for example, when the external device is inside some object or is hidden by some other object. FIG. 15a is a schematic diagram showing the presence of a UWB-connectable smartphone 351 inside a cardboard box 35 in this example. UWB uses a very wide frequency band and is not easily affected by obstacles. Therefore, it is possible to make a UWB connection to a UWB-capable smartphone 351 existing inside the cardboard box 35 from outside the cardboard box 35.

The external device selection support process in this example is the same as in FIG. 5 of Example 1, except that S406, the external device image extraction decision, and S407, the extracted image and position matching decision process, are omitted. By omitting S406 and S407, the external device name is overlaid on the relative position of the external device detected by UWB communication.

For example, in FIG. 15A, smartphone 351 is not directly visible, but the relative position of smartphone 351 is indicated by the dashed line annotation 353 with the device name overlaid. Thus, the user 10 can recognize the presence of the smartphone 351 in the cardboard box 35. In this example, solid line annotation is used for an external device that can be viewed directly, and dashed line annotation is used for an external device that cannot be viewed directly, but this display method is not limited to this. The user 10 can set whether or not to omit processing in S406 and S407. Alternatively, the presence of another object in front of the detected relative position of the external device may be detected by a distance sensor 55 or the like, and the processing of S406 and S407 may be omitted only when the presence of another object is certain. For example, if the distance to the smartphone 351 is detected as 2 m and the distance to the surface of the cardboard box 35 is detected as 1.5 m, it can be processed to determine that the smartphone 351 is hidden by the cardboard box 35 and omit S406 and S407.

As explained above, in this example, the device name of the external device is overlaid even when the external device exists inside or is hidden by other objects. Thus, the correspondence between an invisible external device and its device name is visually consistent, and the user can intuitively select an external device that can be connected.

Another example where the video of the external device cannot be extracted is when the external device exists outside the field of view of the user 10. The following describes the case of an external device outside the field of view.

The external device selection support process when there is an external device outside the field of view is the same as in FIG. 5 in Example 1. However, even if the external device position is judged to be out of range in the in-view range judgment of the external device position in S403, the external device name overlay in S408 is performed. FIG. 15B is a schematic diagram showing an example of annotation when the relative position of the detected external device in this example is outside the field of view of HMD 1. In FIG. 15B, the external device name, the distance to the external device, and the direction of the external device are shown inside the annotation 366. The direction of the external device can be shown, for example, as 0 degrees in front of HMD 1. If the direction of the annotation 366 is aligned with the direction of the external device, the display will be more intuitive. The user 10 may be able to set whether or not the processing of S408 is always performed.

With annotation 366, user 10 can know the relative position and direction of the connectable external device, even if the relative position of the external device is not within the forward view of HMD 1. Once the direction to the external device is known, the user 10 wearing the HMD 1 can position the relative position of the external device within the forward view of the HMD 1 by changing the direction of the face in the direction of the external device.

As described above, according to this example, even if the video of the external device cannot be extracted, the relative position of the external device can be known, and the external device that can be connected can be intuitively selected.

### Example 4

In Example 1, it was assumed that the relative values of external devices can be detected, but this example describes how to handle the case where there are external devices whose relative values cannot be detected. The basic hardware and software configuration in this example is the same as in Example 1. Therefore, this example mainly describes the differences from Example 1, and the common parts are omitted.

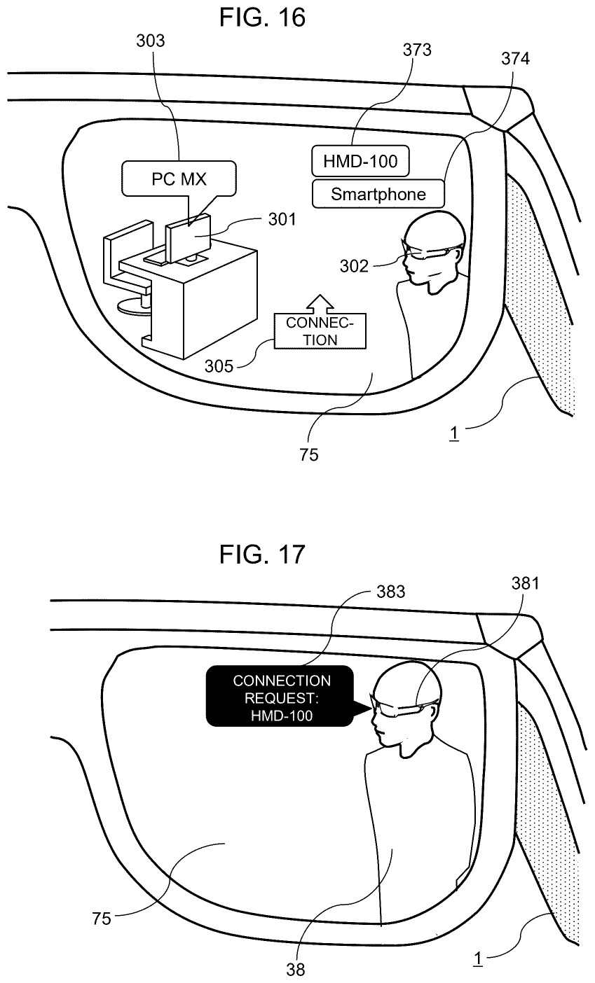

FIG. 16 is a schematic diagram showing an example of the display when there is an external device whose relative position cannot be detected in this example. In FIG. 16, the same configuration as in FIG. 13 is marked with the same symbol and its description is omitted. In FIG. 16, desktop PC 301 is capable of position detection using UWB, and its device name is overlaid in an annotation outline 303 according to the position of desktop PC 301 by the process described in Example 1. On the other hand, the HMD302 and the smartphone outside the display area of the display screen 75 or outside the field of view are external devices that are not equipped with UWB. In this case, the HMD302 and the out-of-view smartphone cannot be position-detected, so they cannot be overlaid according to their positions. However, there is a possible demand for user 10 to connect with those external devices. Therefore, external devices that are not position-detectable can also be displayed in the list as in 373 and 374. Since the position of the external devices whose position cannot be detected is unknown, the display does not suggest their position like the annotation outline 303, but may have a different shape like 373 and 374, which are simply rounded rectangle. The user can determine whether the relative position of the external device has been detected or not by whether the display of the external device name is an annotation or a simple rounded rectangle.

In HMD 1, a conventional text menu for connection can be prepared, in which the external device to be connected is selected from the list of external devices. At this time, when an external device that is capable of position detection is selected from the list, it is also possible to automatically switch from the conventional text menu screen to the overlaid screen display of this example.

According to the above example, the user can select an external device that the user wants to connect with a unified user interface, even when there are external devices to which position detection is not possible. It goes without saying that the above example and this example can be implemented in combination.

### Example 5

In Examples 1 through 4, it was assumed that the user selects an external device to be connected in the HMD, but this example describes a case in which the HMD is selected and connected from an external device. The basic hardware and software configuration of this example is the same as that of Example 1. Therefore, this example mainly describes the differences from Example 1, and the common parts are omitted.

FIG. 17 is a schematic diagram showing the presence of a person 38 wearing HMD 381 in the field of view of HMD 1 in this example. The device name of the HMD 381 is overlaid as an annotation 383 on the display screen 75. In the example, it is assumed that a person 38 wearing HMD 381 selects HMD 1 that user 10 is wearing before user 10 selects the external device.

In this example, when HMD 1 detects that a connection has been made, the device name and information indicating that a connection request has been received are displayed so that the connected external device (HMD 381) can be identified. For this purpose, the annotation 383 is used as a fill-in display and the text color of the device name is changed. By also adding a “connection request” indication, the user 10 can easily recognize that the HMD 381 is the connected external device. Of course, other display methods, such as blinking the annotation 383, may also be used.

According to this example, the correspondence between the connected external device and its device name is visually consistent, and the connected external device can be recognized intuitively.

### Example 6

In Examples 1 through 5, an HMD was used as an example of a portable information terminal. In this example, a smartphone is used as a portable information terminal. The basic hardware and software configuration in this example is the same as in Example 1 Therefore, in this example, the differences from Example 1 are mainly explained, and the common parts are omitted.

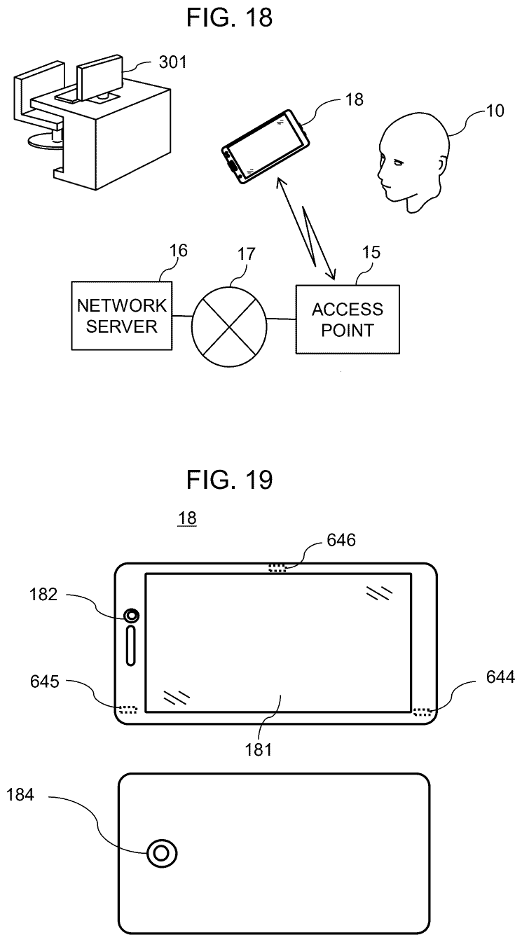

FIG. 18 is a schematic diagram to illustrate the overall system in this example. FIG. 18 shows that user 10 holds smartphone 18 instead of HMD 1 in FIG. 1, and is searching for the existence of an external device that can communicate with smartphone 18 via Bluetooth.

FIG. 19 shows an external view of a smartphone 18, a portable information terminal. In FIG. 19, the upper view shows the front and the lower view shows the rear. The smartphone 18 has a display screen 181 consisting of a touch panel and a front camera 182 on the front, and a rear camera 184 on the back. In addition, the smartphone 18 in this example has a right UWB antenna 644 on the front right edge and a left UWB antenna 644 on the front left edge, and central UWB antenna 646 on the top center of the front, similar to the HMD 1 in the previous example.

The user 10 points the smartphone 18 at the assumed external device and takes a picture using the rear camera 184. The captured image is displayed on display screen 181 of smartphone 18, and the external device name is overlaid with annotation as in the example above. While the example in HMD1 features an overlayed display on the real space image that appears transparent, this example features a overlaid display on the captured image. However, the operation and processing algorithm after the overlaid image is displayed is the same as in the example above, and the effects of the example described above can be applied as they are.

According to this example, the external device selection support process can be performed even for smartphones.

### Example 7

In the previous example, the direction and distance of the external device were detected using UWB, but in this example, a case where the portable information terminal detects the distance and direction of the external device using Bluetooth will be described. The basic hardware and software configuration of this example is the same as in Example 1; therefore, this example mainly describes the differences from Example 1, and the common parts are omitted.

First, the distance to the external device can be estimated to some extent by measuring the signal attenuation using the received signal strength (RSSI: Received Signal Strength Indicator) value of the Bluetooth communication unit 63. For example, if a value indicating the Bluetooth output strength (TxPower) is obtained from the external device, the distance D to the external device can be calculated using the following equation (4).

$$D = 10 \hat{} ( ( TxPower - RSSI ) / 20 ) \qquad ( 4 )$$

Here, the units of TxPower and RSSI are dBm, and the calculation formulas are based on the assumption that the portable information terminal and the external device exist in free space, i.e., in an ideal space without obstacles.

The direction of an external device can be detected by using the Angle of Arival (AoA) and Angle of Departure (AoD) information of Bluetooth. The AoA method is a method in which a transmitter with a single antenna transmits a direction-detecting signal, and a receiver with multiple antennas detects the direction of the transmitter by using the phase difference between the antennas. It uses the fact that the received signal phase of each receiving antenna varies depending on the difference in distance between the transmitting and receiving antennas. In the AoD method, a transmitter with multiple antennas transmits a direction detection signal and obtains the phase information of the received signal from the IQ signal received by the antenna of the receiver, thereby detecting the direction. The AoD-based method requires only one antenna on the receiver. In this example, both AoA and AoD methods can be used.

The hardware configuration block diagram of the HMD, which is the portable information terminal in this example, is same as in FIG. 3, but the UWB communication unit 64 may be omitted because the distance and direction of the external device is detected using Bluetooth. Furthermore, the functional configuration block diagram of this example is the same as FIG. 4. However, the device position calculation process 26 is replaced by a function that transmits and receives between the HMD1 and an external Bluetooth device with Bluetooth communication capability through the Bluetooth connection process 22 and calculates the distance from its RSSI information. If the UWB communication unit 64 in FIG. 3 is omitted, the UWB connection process 24 and UWB device information storage 25 are also omitted.

The flowchart of the external device selection support process in this example is equivalent to FIG. 5, except that if the UWB communication unit 64 in FIG. 3 is omitted, the UWB connection process S440 is omitted. In addition, the external device distance calculation and storage process are performed in the advertisement scan process S420.

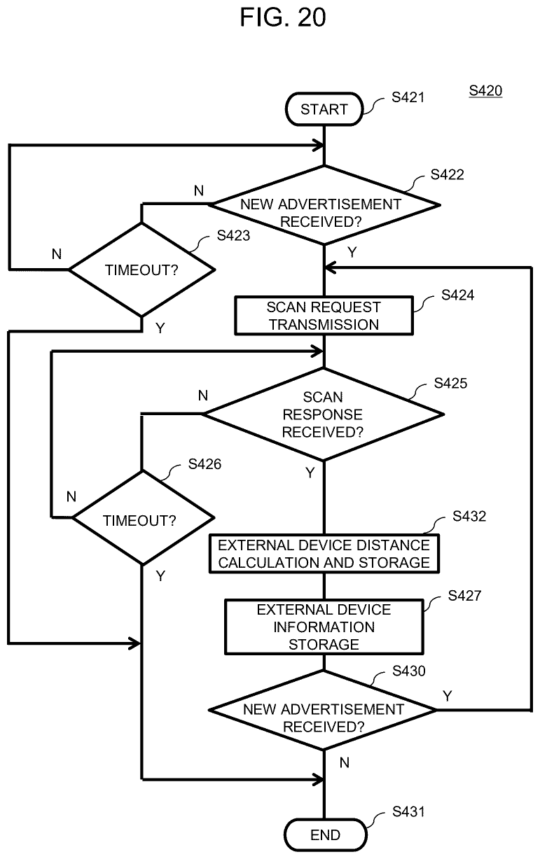

The flowchart of the advertisement scan process S420 in this example is shown in FIG. 20. FIG. 20 is basically the same as FIG. 6, but processes S428 and S429 related to UWB are omitted. Instead, when the scan response reception decision S425 is determined to be Yes, external device distance calculation and storage S432 is added. In S432, the distance to the external device is calculated from the RSSI information as described above. Furthermore, the direction of the external device is calculated using the method by AoA or AoD, and the calculated distance and direction information are stored in the external device information table T800.

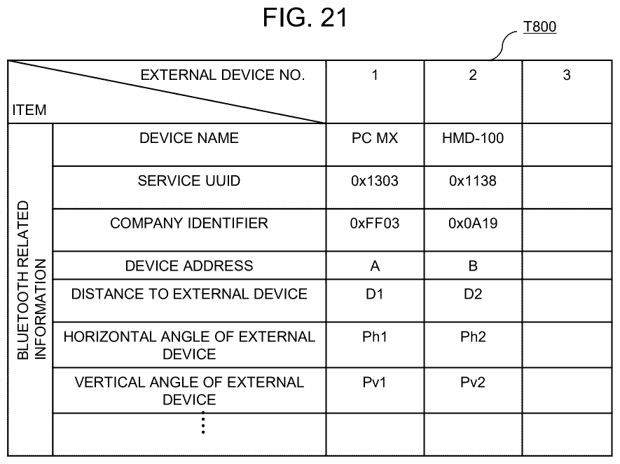

FIG. 21 shows an example of the external device information table T800 when the UWB communication unit 64 in FIG. 3 is omitted. In FIG. 21, for example, the device with external device number 1 stores the distance D1 to the external device, the horizontal angle Ph1 of the external device, and the vertical angle Pv1 of the external device calculated in S432. By storing information that can identify the position of the external device in association with the external device name in this way, it is possible to overlay the external device name on the extracted image that matches the position of the external device.

As described above, according to this example, external device selection support process can be performed using only Bluetooth as a wireless function.

The above examples show how the invention enables intuitive and reliable selection of external devices, hereby contributing to Sustainable Development Goal (SDGs) 9: Create a foundation for industrial and technological innovation, as advocated by the United Nations.

The present invention is not limited to the above examples, but includes various variations. For example, the invention can be applied to portable information terminals other than HMDs and smartphones, such as tablets and personal computer devices including laptops, as long as they have the same functionality as in the example as a portable information terminal.

In the example above, the external device selection support process targets external devices with Bluetooth connectivity, but it can also be applied to external devices with wireless LAN connectivity (specifically, access points). For an external device with Bluetooth connectivity, the device name is used for selection, but for an external device with wireless LAN connectivity, the SSID (Service Set Identifier) is used for selection. The invention can also be applied to the selection of external devices in other connection systems.

It is also possible to replace a part of the configuration of one example with that of another example, or to add the configuration of another example to that of another example, all of which are within the scope of the invention. In addition, the numerical values, messages, etc. that appear in the text and figures are only examples, and the use of different ones does not impair the effects of the invention. The functions of the invention described above may be realized in hardware by designing some or all of them in integrated circuitry, for example, instead of the software process described above. Hardware and software may also be used together. The software may be stored in the program unit 41 of HMD 1 or smartphone 18 at the time of product shipment, or may be obtained from various server devices on the Internet after product shipment. The software may be obtained from a memory card, optical disc, or other media.

### REFERENCE SIGNS LIST

1: HMD, 2, 902: main control unit, 4, 904: memory unit, 5: sensor unit, 6, 906: communication processing unit, 7: video processing unit, 8: audio processing unit, 9: operation input unit, 16: network server, 18: smartphone, 42: various data units, 51: GPS receiver unit, 63: Bluetooth processing unit, 9: operation input unit, 16: network server, 18: smartphone, 42: various data units, 51: GPS receiver unit, 63: Bluetooth communication unit, 64, 964: UWB communication unit, 71: imaging unit, 72: display unit, 75: display screen, 184: rear camera, 301: desktop PC, 303: annotation outline, 641, 644: right UWB antenna, 642, 645: left UWB antenna, 643, 646: central UWB antenna, 711: right camera, 712: left camera

1. A portable information terminal that can be connected wirelessly to an external device, comprising:
a first communication function and a second communication function that can be connected wirelessly to the external device,
a camera that captures video of a surrounding of the portable information terminal,
a video processing unit that processes the video captured by the camera,
a display that shows the video processed by the video processing unit,
a memory unit that stores first identification information of the external device used in the first communication function and second identification information of the external device used in the second communication function, and
a control unit, wherein
the control unit calculates a relative position of the external device to the portable information terminal using the second communication function, and
the video processing unit generates an overlaid video in which the first identification information is overlaid on the calculated relative position of the external device in the video and displays it on the display.

2. The portable information terminal according to claim 1, wherein
the control unit can also obtain the first identification information using the second communication function, or the second identification information using the first communication function.

3. The portable information terminal according to claim 2, wherein
the memory unit stores the first identification information and the second identification information correspondingly for each external device.

4. The portable information terminal according to claim 1, wherein
the control unit extracts an outline of the external device that exists at the relative position of the external device from the video captured by the camera, and
the video processing unit performs video processing that enables the extracted external device to be discriminated.

5. The portable information terminal according to claim 1, wherein
the first communication function is a Bluetooth communication function and the second communication function is a UWB communication function, and
The first identification information is a device name of the external device.

6. The portable information terminal according to claim 1, wherein
the video processing unit changes the display of the overlaid video according to an accuracy of the calculated relative position of the external device.

7. The portable information terminal according to claim 4, wherein
the video processing unit changes the display of the overlaid video according to an extraction accuracy of the extracted external device outline.

8. The portable information terminal according to claim 1, wherein
when there are multiple calculated relative positions of the external device within a certain area, the video processing unit changes the display of the overlaid video so that the multiple external devices can be distinguished.

9. The portable information terminal according to claim 1, wherein
when the calculated relative position of the external device is outside the display area of the display, the video processing unit changes the display of the overlaid video compared to when it is inside the display area.

10. The portable information terminal according to claim 9, wherein
the video processing unit generates an overlaid video showing the first identification information and the calculated relative position direction of the external device.

11. The portable information terminal according to claim 1, wherein
when the video processing unit receives a connection request from the external device, the video processing unit generates an overlaid video in which the first identification information and the information indicating that the connection request was received are overlaid on the relative position of the external device.

12. The portable information terminal according to claim 1, further comprising:
a selection unit that selects the external device, wherein
the selection unit is capable of handling two selection methods: a first method of selecting the overlaid first identification information, and a second method of selecting by displaying a list of external devices that can be connected wirelessly, and
if the control unit can calculate relative position of the external device selected by the second selection method, the control unit switches to the first selection method.

13. An external device that can be connected wirelessly to a portable information terminal, comprising:
a first communication function and a second communication function that can be connected wirelessly to the portable information terminal, and
a memory unit that stores first identification information used in the first communication function and second identification information used in the second communication function, wherein
the first identification information is transmitted by the first communication function, and
the second identification information is transmitted by the first identification in addition to the second communication function.

14. The external device according to claim 13, wherein
the first and second communication functions are Bluetooth and UWB communication functions, or UWB and Bluetooth communication functions, respectively.

15-16. (canceled)

17. A portable information terminal that can be connected wirelessly to an external device, comprising:
a Bluetooth communication function that enables wireless connection to the external device,
a camera that captures video of a surrounding of the portable information terminal,
a video processing unit that processes the video captured by the camera,
a display that shows the video processed by the video processing unit,
a memory unit that stores a device name of the external device used in the Bluetooth communication function, and
a control unit, wherein
the control unit calculates a relative position of the external device to the portable information terminal using the Bluetooth communication function, and
the video processing unit generates an overlaid video in which the device name is overlaid on the calculated relative position of the external device in the video and displays it on the display.
